(19) United States
(12) Patent Application Publication
(10) Pub. No.: US 2025/0042366 A1
(43) Pub. Date: Feb. 6, 2025

(54) END CAP AND WINDSCREEN-WIPER BLADE FOR A MOTOR VEHICLE

(71) Applicant: VALEO SYSTEMES D'ESSUYAGE, La Verriere (FR)

(72) Inventors: Gérald CAILLOT, La Verriere (FR); Philippe BILLOT, La Verriere (FR); Vincent IZABEL, La Verriere (FR)

(73) Assignee: VALEO SYSTEMES D'ESSUYAGE, La Verriere (FR)

(21) Appl. No.: 18/716,998

(22) PCT Filed: Dec. 14, 2022
(86) PCT No.: PCT/EP2022/085781

§ 371 Date: Jun. 6, 2024

(30) Foreign Application Priority Data
Dec. 16, 2021 (FR) FR2113711

(51) Int. Cl. B60S 1/38

(52) U.S. Cl. CPC B60S 1/3894; B60S 1/381

(57) ABSTRACT

The invention concerns an endpiece of a windshield wiper for a motor vehicle, the shape and dimensions of which make it possible to guarantee efficient aerodynamic support up to the end of the wiper blade against a glass surface for a motor vehicle that is to be wiped/cleaned. This efficient aerodynamic support is obtained in particular due to a curved shape of the guiding profile along which extends the deflection device located above the hollow body, the curved shape of the guide profile being oriented towards a front side wall of the endpiece according to the invention.

### TECHNICAL FIELD

The present invention relates to the wiping of glazed surfaces of motor vehicles. The present invention is particularly advantageously applicable to wiper assemblies for a front glazed surface, such as a windshield, of such motor vehicles. In particular, the present invention relates to an endpiece and to a windshield wiper for a motor vehicle.

### BACKGROUND OF THE INVENTION

As is known, wiper systems for motor vehicles comprise at least one drive arm and one windshield wiper which has a squeegee blade intended to bear against a glazed surface of the motor vehicle. The drive arm is driven in an angular back-and-forth movement against the glazed surface of the motor vehicle, during which it drives the windshield wiper and its squeegee blade such that the blade rubs the glazed surface and removes from it the water, dirt and dust that can impair the view the driver of the motor vehicle has of their surroundings.

As is known, the windshield wiper is attached to the drive arm by a connection assembly which comprises a connector secured to the windshield wiper and an adapter configured to interact with the windshield wiper and with a terminal part of the drive arm. This connection assembly is configured both to enable the back-and-forth movements of the squeegee blade against the glazed surface in question and to ensure the squeegee blade is effectively pressed against the glazed surface in order to perform effective wiping and/or cleaning.

One drawback of the known wiper systems for motor vehicles is linked to the lack of uniformity and effectiveness of the wiping and/or the cleaning over the entire length of the squeegee blade, and more particularly at one longitudinal end.

An object of the present invention is to propose a novel windshield wiper endpiece in order to at least largely overcome the problems set out above and also bring about further advantages.

Another aim of the invention is to improve the downforce of the windshield wiper at its longitudinal end.

Another aim of the invention is to improve the effectiveness of the cleaning and/or wiping of a motor vehicle windshield, notably at the longitudinal end of the windshield wiper.

Another aim of the invention is to improve the homogeneity of the cleaning and/or wiping of a motor vehicle windshield.

According to a first aspect of the invention, at least one of the aforementioned objectives is achieved by an endpiece of a windshield wiper for a motor vehicle, the endpiece comprising (i) a hollow body extending, in a longitudinal direction, between a first edge configured to be in engagement with a windshield wiper end and a second, free, edge configured to be remote from the windshield wiper end, (ii) an airstream deflecting device projecting from the hollow body along a guide profile defined by the set of apexes of the deflecting device relative to the hollow body, the deflecting device extending between the first edge and the second edge of the hollow body. According to the invention, the guide profile of the deflecting device has an amplification portion curved in a plane parallel to the longitudinal direction and including the guide profile.

The plane in which a curved orientation—forming the amplification portion—of the guide profile is defined is, for example, within the meaning of the invention, the plane formed by the longitudinal direction and a transverse direction of the endpiece according to the first aspect of the invention.

The longitudinal direction is the main direction of extent of the windshield wiper and/or its squeegee blade. The longitudinal direction is also, by extension, the main direction of the endpiece according to the first aspect of the invention and along which the endpiece is assembled at the windshield wiper tip.

The deflecting device, for the one part, extends in a substantially longitudinal direction between the first edge and the second edge of the hollow body and, for the other part, projects in a direction substantially perpendicular to the aforementioned longitudinal direction. In a windshield wiper equipped with an endpiece according to the first aspect of the invention, the direction of extent of this projection is substantially parallel to a direction in which the windshield wiper is connected to its squeegee blade. In a motor vehicle equipped with a wiper system comprising such a windshield wiper, the direction of extent of the projection mentioned above is substantially perpendicular to the glazed surface against which the windshield wiper is placed, and represents a direction in which the squeegee blade bears against this glazed surface.

### SUMMARY OF THE INVENTION

In the context of the invention, the direction of extent of this projection is arbitrarily designated as forming a vertical direction of the endpiece according to the first aspect of the invention. Furthermore, in this direction, that part of the deflecting device that is closest to the hollow body in the aforementioned vertical direction is designated as the lower part of the deflecting profile and, in complementary fashion, that edge of the deflecting device that is furthest away from the hollow body in the vertical direction is designated as the upper edge of the deflecting device. Consequently, the deflecting device extends from a lower part, which starts on the hollow body of the endpiece according to the first aspect of the invention, to an upper edge, which is remote from the aforementioned hollow body in the vertical direction defined above. The deflecting device therefore forms a vertical extension of the hollow body.

The transverse direction is the direction perpendicular both to the longitudinal direction and to the vertical direction, such that the longitudinal, vertical and transverse directions together form an orthogonal system of axes of the endpiece according to the first aspect of the invention. In other words, in a wiper system comprising a windshield wiper equipped with an endpiece according to the first aspect of the invention bearing against a glazed panel of a motor vehicle, such as for example a windshield, the transverse direction of the endpiece—or of the windshield wiper—is the direction between a first face—referred to as front face or front lateral wall—of the endpiece located in the vicinity of a lower edge of the glazed wall and a second face—referred to as rear face of the endpiece located in the vicinity of an upper edge of the glazed wall.

By extension, the longitudinal, vertical and transverse directions of the endpiece are also designated in the following text as longitudinal, vertical and transverse directions of a windshield wiper equipped with such an endpiece according to the first aspect of the invention.

According to the invention, the hollow body of the endpiece extends in the longitudinal direction, parallel to the windshield wiper and to the squeegee blade of the latter. More particularly, the hollow body of the endpiece according to the first aspect of the invention forms a cavity in which the end of the windshield wiper is to be received. In the following text, the first edge of the endpiece according to the first aspect of the invention is intended to be placed at the free longitudinal end of the windshield wiper, and the second, free, edge of the endpiece is remote from the first edge in the longitudinal direction defined above: it is at a distance from the free longitudinal end of the windshield wiper.

Advantageously, the hollow body is closed at its end that is by the second edge in the longitudinal direction, and is open at its end that is by the first edge in the longitudinal direction. In other words, the hollow body of the endpiece according to the first aspect of the invention forms a cap in which the free end of the windshield wiper is to be push-fitted. In the rest of the description, the open longitudinal end of the endpiece according to the first aspect of the invention will be arbitrarily defined as the first end of the endpiece, and the closed longitudinal end of the endpiece according to the first aspect of the invention will be arbitrarily defined as the second end of said endpiece. Furthermore, the first edge of the hollow body of the endpiece according to the first aspect of the invention will also be indiscriminately defined as the first edge of the endpiece, and the second edge of the hollow body of the endpiece according to the first aspect of the invention will also be indiscriminately defined as the second edge of the endpiece.

The deflecting device of the endpiece according to the invention extends between the first edge and the second edge of the hollow body and protrudes from said hollow body in the vertical direction perpendicular to the longitudinal direction defined above.

With reference to the preceding text, in the endpiece according to the first aspect of the invention, the guide profile of the deflecting device is formed by the set of points, or apexes, that define the upper edge, defined above, of the deflecting device. In other words, the apexes forming the upper edge of the deflecting device are those located further away from the hollow body, in a perpendicular direction with respect to a local surface of the hollow body that is vertically in line with the apexes in question and forms the guide profile.

According to the invention, the guide profile defined above has an amplification portion curved in a plane parallel to the longitudinal direction and including the guide profile.

With reference to the directions and orientations defined above, it must be understood here that the position of the deflecting device varies, in the curved amplification portion, relative to a plane containing the aforementioned longitudinal direction.

In other words, in the curved amplification portion, a distance measured, in the transverse direction or in the vertical direction that were defined above, between the deflecting device and a plane as defined above that contains the longitudinal direction, varies. In other words, in the curved amplification portion of the deflecting device, there are at least two tangents to the guide profile that are not mutually parallel, that is to say that they intersect. In yet other words, within the meaning of the invention, the guide profile is curved in its amplification portion if, in the direction transverse to the endpiece according to the first aspect of the invention, a direction which is perpendicular to the guide profile and extends from the rear face of the hollow body toward the front lateral wall of the hollow body, the relative position of the deflecting device in relation to the front lateral wall of the hollow body varies along the amplification portion. In yet other words, it will be understood that the amplification portion of the guide profile is curved when it is not rectilinear. In yet other words, curved is understood to mean that the amplification portion of the guide profile curves without containing any straight-line portions, or that the amplification portion of the guide profile curves or changes direction without forming an angle.

The deflecting device thus has a changing shape, notably in the amplification portion. This changing shape makes it possible to amplify the downforce of the endpiece according to the invention.

Within the context of the invention, the shape of the guide profile and/or of its amplification portion does not correspond to the morphology of the deflecting device, which protrudes from the hollow body and along said guide profile. In other words, the deflecting device may take any shapes along the guide profile and/or its amplification portion.

As a result, within the context of the invention according to its first aspect, the deflecting device has a changing shape along a portion, referred to as amplification portion, of the guide profile.

Changing shape is understood to mean that the deflecting device, which protrudes from the hollow body and along the guide profile, may exhibit, between the first edge and the second edge of the hollow body:
one and the same overall shaping and a dimension which can vary in at least one direction; and/or
one and the same overall shaping and curved guide profile over its amplification portion.

Same overall shaping is understood to mean that a cross section through the deflecting device retains the same envelope, possibly apart from at least one dimension.

According to a first embodiment, the deflecting device has one and the same cross section along the guide profile, the guide profile then being necessarily curved at its amplification portion. According to a second embodiment, the deflecting device has multiple different cross sections between the first edge and the second edge of the hollow body, the guide profile then being curved in its amplification portion. In this second embodiment, the envelope of the deflecting device develops, for example, along its guide profile and/or its amplification portion, homothetically between the first edge and the second edge.

The endpiece according to the first aspect of the invention advantageously comprises at least one of the refinements below, it being possible for the technical features forming these refinements to be taken alone or in combination:
the deflecting portion has (i) a first portion along which the deflecting device has a constant shape; and (ii) a second portion forming the amplification portion, the second part being located in the continuation of the first portion. It should be noted that the first portion and the second portion of the guide profile of the deflecting device define a first portion and a second portion of the deflecting device of which the guide profile forms the upper edge as described above. In this case, constant shape is understood to mean that a cross section, as defined above, of the deflecting device has a shape and dimensions that are constant over the entire length of the first part of the deflecting device and of the associated guide profile. In other words, the deflecting device has one and the same overall shaping, that is to say identical dimensions, along the first part of the guide profile. In yet other words, along the first part of the guide profile, a cross section through the deflecting device remains identical at all points of said guide profile along said first part;
the first part of the deflecting device is in the vicinity of the open end of the hollow body, which is to say, with reference to the directions and orientations defined above, in the vicinity of the first edge of the endpiece according to the first aspect of the invention. The second part of the deflecting device, forming the curved amplification portion of the guide profile, is in the vicinity of the second edge of the endpiece according to the first aspect of the invention, which is to say also in the vicinity of the closed end of the hollow body;
the second part of the deflecting device, forming the curved amplification portion of the guide profile, continues the first part of the deflecting device beyond a median plane of the endpiece that comprises the longitudinal and transverse directions.

Expressed differently, the second part of the deflecting device, forming the curved amplification portion of the guide profile, continues the first part of the deflecting device beyond a longitudinal median axis of the endpiece;
the second part of the deflecting device, forming the curved amplification portion of the guide profile, continues the first part of the deflecting device and extends to the second edge of the hollow body and the endpiece;
the guide profile is rectilinear along the first part of the deflecting device, and the guide profile is curved along the second part of the deflecting device;
a length of the first part of the guide profile of the deflecting device is between about 15% and 25% of a total length of the endpiece according to the first aspect of the invention, measured between the first edge and the second edge of the hollow body;
in particular, a length of the first part of the guide profile of the deflecting device is between 5 millimeters and 10 millimeters, for example around 6.5 to 7.5 millimeters;
the amplification portion has a curved shape, the curvature of which is directed toward a front lateral wall of the hollow body. Within the context of the invention, the front lateral wall is that face of the hollow body that is intended to be located by a motor vehicle front hood when the endpiece according to the first aspect of the invention is mounted on a windshield wiper, which itself is implemented on a motor vehicle windshield. In complementary fashion, the direction of the curvature of the amplification portion of the guide profile should therefore be regarded as along the transverse direction defined above;
the amplification portion has a substantially concave shape, the concavity of which is directed toward the front lateral wall of the endpiece according to the first aspect of the invention. In other words, the amplification portion of the guide profile forms a comma oriented in the direction from the first edge of said hollow body in the direction toward the front lateral wall of the hollow body;
the curved nature of the amplification portion can take numerous shapes. In particular, and according to various non-limiting embodiment variants of the invention according to its first aspect, the amplification portion of the guide profile has a substantially circular or elliptical shape in cross section in a transverse longitudinal plane;
in the vicinity of the first edge of the hollow body, a distance, measured in the transverse direction, between the amplification portion and a vertical longitudinal median plane passing through the middle, in the transverse direction, of the first portion of the guide profile is less than 5 millimeters, for example between 2.5 and 3.5 millimeters, for example around 3 millimeters;
a distance, measured in the longitudinal direction, between the first edge of the hollow body and that part of the amplification portion that is furthest away from the aforementioned median plane in the transverse direction is between 5 and 10 millimeters, for example between 7.5 and 8.5 millimeters, for example around 8 millimeters;
according to a first embodiment variant, a height of the deflecting device varies in increasing fashion along the amplification portion and in the direction toward the second edge of the hollow body. This advantageous configuration makes it possible to variably increase the downforce in proportion to the variation in height of the deflecting device. In this case, the height should be understood as meaning a dimension, measured substantially in the vertical direction defined above, between the lower edge of the deflecting device and the guide profile of the deflecting device. More specifically, at a given point of the guide profile of the deflecting device, the height of the deflecting device is its dimension measured between the guide profile of the deflecting device and the hollow body in a direction perpendicular to said hollow body and passing through the point in question of the guide profile;
if the height of the deflecting device varies in increasing fashion along the amplification portion, from the first edge of the hollow body to the second edge thereof, the height of the deflecting device, measured in the vicinity of the second edge of the hollow body of the endpiece according to the first aspect of the invention, is thus greater than the height of the deflecting device measured in the vicinity of the first edge of the hollow body that was mentioned. Advantageously, the difference between these two heights is around a few millimeters, preferably less than 5 millimeters, for example between 1.5 and 2.5 millimeters. According to an advantageous example, this difference in height is around 2 millimeters;
according to a second embodiment variant, a height of the deflecting device varies in decreasing fashion along the amplification portion and in the direction toward the second edge of the hollow body;
if the height of the deflecting device varies in decreasing fashion along the amplification portion, a difference between the height of the deflecting device measured in the vicinity of the second edge of the hollow body and a height of the deflecting device measured in the vicinity of the first hollow edge is around 5 to 10 millimeters, advantageously between 5.5 and 7.5 millimeters, preferably around 6 millimeters. In other words, the height of the deflecting device measured in the vicinity of the second edge of the hollow body is approximately 6 millimeters less than the height of the deflecting device measured in the vicinity of the first edge of the hollow body;
if the height of the deflecting device varies in increasing or decreasing fashion, the height of the deflecting device varies monotonously along the amplification portion;
if the height of the deflecting device varies in increasing or decreasing fashion, the variation in height of the deflecting device is linear or non-linear along the amplification portion;
if the variation in height of the deflecting device is non-linear, the variation in height of the deflecting device along the amplification portion has an inflection;
according to a third embodiment variant, a height of the deflecting device is constant along the amplification portion;
at a part of the amplification portion which is proximal to the second end of the hollow body, a width of the deflecting device is less than the width of said deflecting device at the first edge of the hollow body. In this case, the width should be understood to mean the dimension of the deflecting device measured in the transverse direction.

A second aspect of the invention proposes a windshield wiper comprising a blade and a support element, wherein the blade is secured to the support element by an endpiece according to the first aspect of the invention or according to any one of its refinements. Of course, within the context of the present invention, the support element of the windshield wiper has one or more vertebrae for bending the windshield wiper in the direction toward a windshield of a motor vehicle on which the windshield wiper is mounted. Thus, the invention according to its first aspect is suitable both for semi-rigid windshield wipers, of the “flat blade” type, having a single vertebra that ensures the bending of the blade, and for semi-rigid windshield wipers having two or more vertebrae accommodated in the support element.

In general, the endpiece according to the first aspect of the invention is configured to be implemented with any type of windshield wiper of which the endpiece is fitted on the support element or of which the endpiece is made in one piece with said support element.

Advantageously, the windshield wiper comprises an air deflector of which the endpiece as described above forms a longitudinal continuation. In other words, the windshield wiper extends, in the longitudinal direction defined above, between a first longitudinal end and a second longitudinal end, at least one of the aforementioned longitudinal ends being received in the hollow body of an endpiece according to the first aspect of the invention or according to any one of its refinements, such that the deflecting device of said endpiece forms a longitudinal continuation of the air deflector of the windshield wiper.

A third aspect of the invention proposes a wiper system for a glazed surface of a motor vehicle, the wiper system having:
a windshield wiper according to the second aspect of the invention, the windshield wiper being intended to be brought into contact with the glazed surface,
a wiper arm configured to drive the windshield wiper in rotation,
a connection device configured to securely fix the windshield wiper to the wiper arm.

### BRIEF DESCRIPTION OF DRAWINGS

Other features and advantages of the invention will become more clearly apparent both from the following description and from the exemplary embodiments, which are given by way of non-limiting indication with reference to the attached schematic drawings, in which:

FIG. 1 illustrates a perspective view of an exemplary embodiment of a windshield wiper according to the second aspect of the invention;

FIG. 2a illustrates a perspective view of an exemplary embodiment of an endpiece according to the invention and implemented on a windshield wiper like the one illustrated in FIG. 1;

FIG. 2b illustrates a top view of the exemplary embodiment of the endpiece illustrated in FIG. 2a;

FIG. 3a illustrates a side view of a first embodiment of the endpiece;

FIG. 3b illustrates a side view of a second embodiment of the endpiece; and

FIG. 3c illustrates a side view of a third embodiment of the endpiece.

### DETAILED DESCRIPTION OF THE INVENTION

Of course, the features, variants and different embodiments of the invention may be combined with one another, in various combinations, provided that they are not mutually exclusive or incompatible. In particular, it is possible to envisage variants of the invention that comprise only a selection of features that are described below in isolation from the other described features, if this selection of features is sufficient to provide a technical advantage or to differentiate the invention from the prior art.

In particular, all of the variants and all of the embodiments described are able to be combined with one another if there is no technical reason preventing this combination.

In the figures, elements that are common to several figures have the same reference.

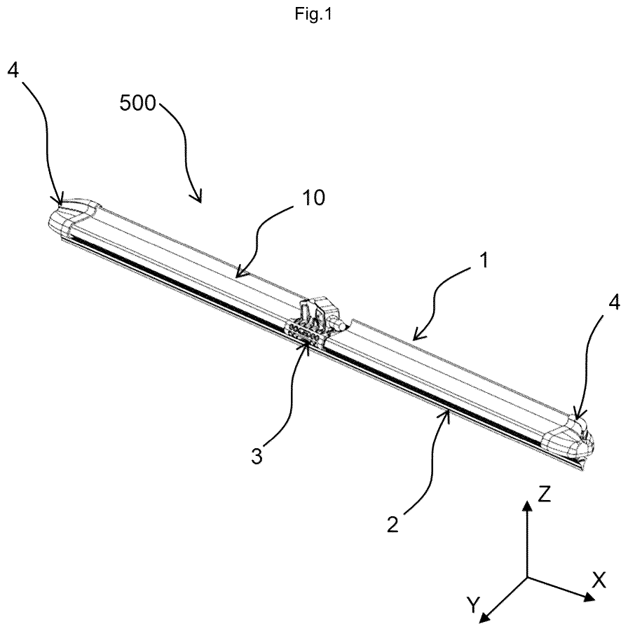

FIG. 1 schematically illustrates a windshield wiper 500 according to the second aspect of the invention and according to a first exemplary embodiment.

With reference to FIG. 1, the windshield wiper 500 has an elongate first part 1, from which a squeegee blade 2 made of an elastic material extends. The first part 1 of the windshield wiper 500 thus forms a support element for the squeegee blade 2.

Of course, within the context of the present invention, the first part 1 of the windshield wiper 500 has one or more vertebrae for bending the windshield wiper 500 in the direction toward a windshield of a motor vehicle on which the windshield wiper 500 is mounted.

In the following text, the main direction of elongation of the windshield wiper 500 and its squeegee blade 2 is referred to as longitudinal direction of the windshield wiper, embodied by the direction of an axis X. With reference to this longitudinal direction, a direction perpendicular to the longitudinal direction X and connecting the first part 1 of the windshield wiper 500 to the squeegee blade 2 is also referred to in the following text as vertical direction, embodied by the direction of an axis Z. In a motor vehicle equipped with a windshield wiper 500 according to the invention, the vertical direction is the direction in which the squeegee blade 2 bears against the glazed surface to be wiped and/or cleaned, which is to say substantially the direction perpendicular to this glazed surface. In addition, in the following text, the direction perpendicular to the longitudinal direction X and to the vertical direction Z is referred to as transverse direction, embodied by the direction of an axis Y, such that the coordinate system (X, Y, Z) forms an orthogonal trihedron.

With reference to these different directions and to FIG. 1, in the following text the qualifier “front” denotes the positive direction of the transverse axis Y and the qualifier “rear” denotes the negative direction of the transverse axis Y. In a motor vehicle of which a front windshield is equipped with a windshield wiper 500 according to the invention, the qualifier “front” corresponds to the part that is exposed to the wind first when the motor vehicle is moving.

In complementary fashion, in the following text the qualifiers “upper” or “above” denote the positive direction of the vertical axis Z and the qualifiers “lower” or “below” denote the negative direction of the vertical axis Z.

With reference to the above text, the windshield wiper 500 extends mainly longitudinally between a first end and a second end, and the squeegee blade 2 extends substantially over the entire longitudinal dimension of the first part 1 of the windshield wiper 500, below said first part 1 with reference to the directions and orientations defined above.

In order to be able to be connected to a drive arm, not shown in FIG. 1, of a wiper system of the motor vehicle, the windshield wiper 500 is equipped, substantially in the median position along its longitudinal direction X, with a connector 3 configured to interact with an adapter, not shown in FIG. 1.

Furthermore, the windshield wiper 500 has an endpiece 4 according to the first aspect of the invention at each of its ends in the longitudinal direction X.

As shown in FIG. 1, each endpiece 4 covers one longitudinal end of the first part 1 of the windshield wiper 500 while at the same time leaving the corresponding longitudinal end of the squeegee blade 2 free.

According to the exemplary embodiment more particularly illustrated in FIG. 1, the first part 1 of the windshield wiper 500 has an air deflector 10 which extends substantially over the entire longitudinal dimension of the first part 1 in the longitudinal direction defined above. The air deflector 10 also extends in the vertical direction defined above, above the first part 1 with reference to the directions and orientations defined above.

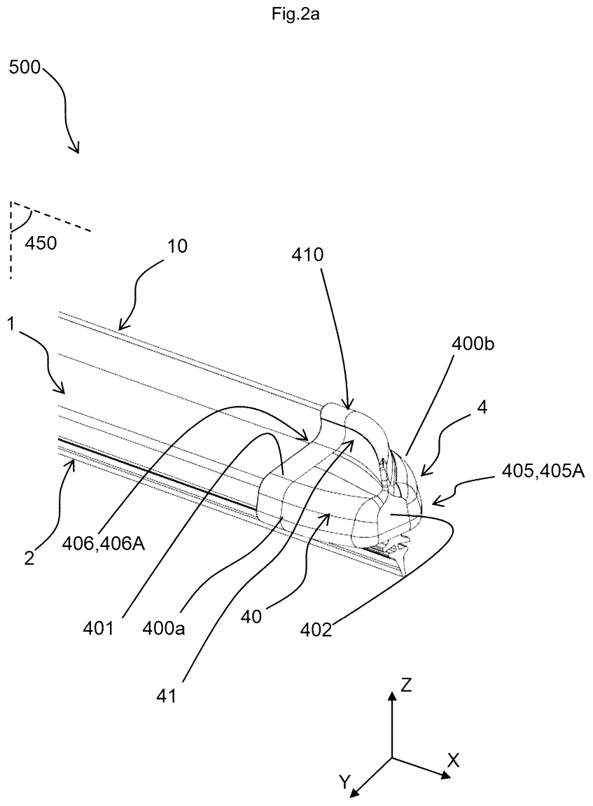

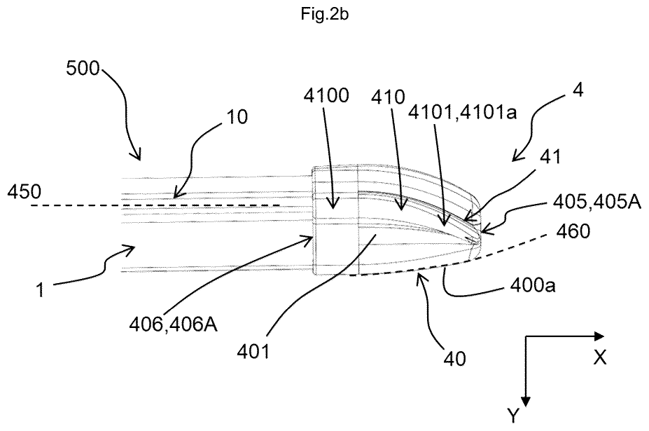

FIG. 2a is a detail view of one longitudinal end of a windshield wiper 500 like the one illustrated in FIG. 1. FIG. 2a shows the windshield wiper 500, its first part 1, the squeegee blade 2 and the endpiece 4.

With reference to FIG. 2a, the endpiece 4 has a hollow body 40 configured to receive the longitudinal end of the first part 1 of the windshield wiper 500 by push-fitting.

The hollow body 40 comprises a front lateral wall 400a and a rear lateral wall 400b, of complex shape, that are joined to one another by an upper wall 401 with a longitudinal and transverse main extent. At one of their longitudinal edges, denoted in the following text as second edge 405 of the hollow body 40 and of the endpiece 4, the lateral walls 400a, 400b and the upper wall 401 are joined to one another by an end wall 402, such that the hollow body 40 is closed by the end wall 402. This closed end of the hollow body 40 is also denoted as second end 405a of the endpiece 4 by extension in the following text. At their opposite longitudinal edge, denoted in the following text as first edge 406, the lateral walls 400a, 400b and the upper wall 401 form an opening of the cavity that they delimit together, which cavity is configured to receive the free longitudinal end of the first part 1 of the windshield wiper 500 by push-fitting. By extension, in the following text, this first end of the hollow body 40 will also be denoted as first end 406a of the endpiece 4.

The hollow body 40 is advantageously monolithic, for example obtained by injection molding or by additive manufacture, such as by 3D printing. As an alternative, the hollow body 40 is obtained by assembling multiple parts that are connected to one another by snap-fitting members, for example, or adhesively bonded. The hollow body 40 is preferably made from plastic.

The lateral walls 400a, 400b, the upper wall 401 and the end wall 402 have a non-planar, complex shape, such that the inner volume of the cavity delimited by these walls complements the shape of the first part 1 of the windshield wiper 500 at its free longitudinal end, thus making it possible to insert the free longitudinal end of the windshield wiper 500 into the aforementioned cavity.

According to the invention, the endpiece 4 also comprises a deflecting device 41 which extends from the upper wall 401 of the hollow body 40 in the vertical direction defined above. More specifically, the deflecting device 41, of complex shape, extends, with reference to the directions and orientations defined above, upward from the upper wall 401 of the hollow body 40, substantially perpendicularly to said upper wall 401, to an apex 410 also denoted in the above and following text as guide profile 410 of the deflecting device 41. The guide profile 410 of the deflecting device 41 thus forms the upper edge of said deflecting device 41.

As shown in FIG. 2a, the deflecting device 41 extends from the first edge 406 of the hollow body 40 to the second edge 405 of this hollow body while forming a continuation of the air deflector 10 of the first part 1 of the windshield wiper 500 from the first edge 406 in the direction toward the second edge 405.

On the endpiece 4, the deflecting device 41 follows the guide profile 410. In other words, a position and/or an orientation and/or an elongation of the deflecting device 41 protruding from the hollow body 40 are defined by the guide profile 410 of the deflecting device 41.

The deflecting device 41 might have a symmetrical cross section with respect to a vertical plane passing through the guide profile 410. As an alternative, the deflecting device 41 has an asymmetrical cross section with respect to a vertical plane passing through the guide profile 410.

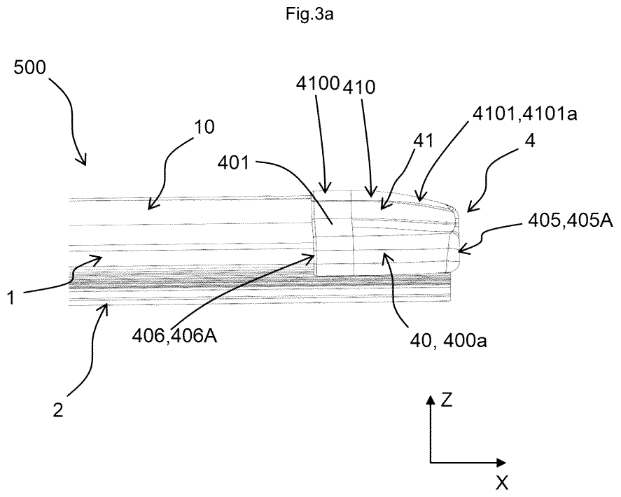

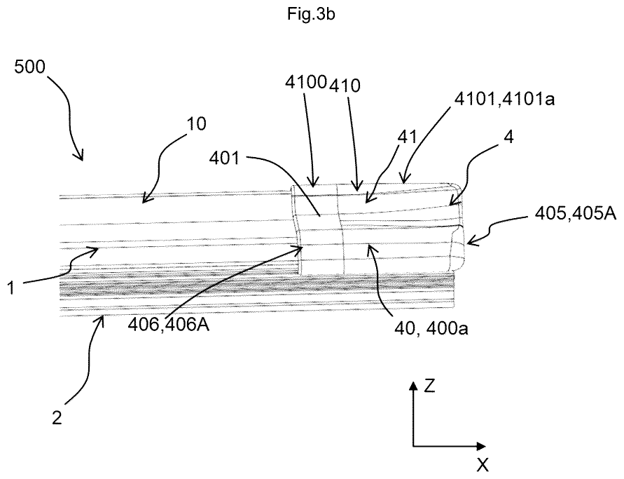

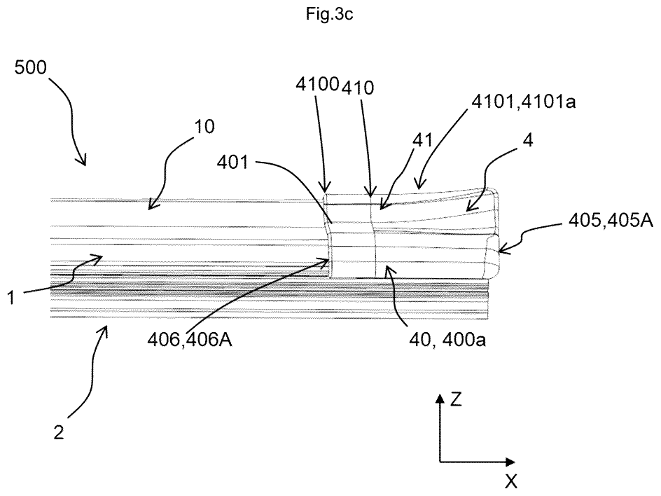

Within the context of the invention, multiple embodiment variants of a shape and/or an orientation and/or an elongation of the guide profile 410—and, by extension, of the deflecting device 41 protruding from the hollow body 40—are provided and illustrated in FIGS. 3a to 3c. In particular:
FIG. 3a illustrates a first embodiment in which the deflecting device 41 follows a guide profile 410 which is curved and oriented to the front, a height of the deflecting device 41 decreasing in the direction toward the second edge 405 of the hollow body 40;
FIG. 3b illustrates a second embodiment in which the deflecting device 41 follows a guide profile 410 which is curved and oriented to the front, a height of the deflecting device 41 being constant along said guide profile 410;
FIG. 3c illustrates a third embodiment in which the deflecting device 41 follows a guide profile 410 which is curved and oriented to the front, a height of the deflecting device 41 increasing in the direction toward the second edge 405 of the hollow body 40.

According to a embodiment shown in FIG. 2b, the deflecting device 41 has a curved shape, a center of curvature of which is located by the front lateral wall 400a of the hollow body 40 in the transverse direction Y. In other words, in this embodiment, the guide profile 410 that the deflecting device 41 follows has, in a plane-referred to as transverse longitudinal plane-formed by the longitudinal direction and the transverse direction of the endpiece 4, an extension curved over all or some of said guide profile, between the first edge 406 and the second edge 405 of the hollow body 40. In yet other words, the guide profile 410 has the shape of a comma oriented to the front of the hollow body 40 in this plane. In yet other words, the guide profile 410 and the deflecting device 41 have a concavity by a front lateral wall of the hollow body 40. The embodiments illustrated in FIGS. 3a, 3b and 3c all stem from this exemplary embodiment.

Thus, FIG. 2b illustrates more particularly an endpiece 4 like the one shown in FIG. 2a, in a top view, which is to say, with reference to the directions defined above, in a view in a transverse longitudinal plane. FIG. 2b shows the windshield wiper 500, its first part 1 and its air deflector 10, and also the endpiece 4, its hollow body 40 and its deflecting device 41, and also the first edge 406 and the second edge 405 of the hollow body 40. More specifically, FIG. 2b shows the upper wall 401 of the hollow body 40 and the guide profile 410 of the deflecting device 41.

As shown in FIG. 2b, the guide profile 410 of the deflecting device 41, which is to say the upper edge of said deflecting device 41, has, from the first edge 406 and in the direction toward the second edge 405, a substantially rectilinear first portion 4100 which is parallel to the longitudinal direction X, and a curved second portion 4101, referred to as amplification portion 4101a, which continues the first portion 4100 and extends to the second edge 405 of the hollow body 40 and of the endpiece 4.

Advantageously, the first portion 4100 of the guide profile 410 of the deflecting device 41 covers between 15% and 25% of a total length of the endpiece 4, measured between the first edge 406 and the second edge 405 of the latter. The length of the first portion 4100 of the guide profile 410 is, for example, between 5 and 10 millimeters, for example between 6.5 and 7.5 millimeters, preferably around 7 millimeters.

In this exemplary embodiment illustrated in FIG. 2b, a distance, measured in the transverse direction Y, between the second portion 4101 of the guide profile 410 and a surface 460 containing the front lateral wall 400a of the hollow body 40 and continuing said front lateral wall 400a in the vertical direction Z, decreases in the direction toward the second edge 405 of the endpiece 4.

More specifically, with reference to a vertical longitudinal plane 450 shown in FIG. 2a that passes through the middle, in the transverse direction Y, of the first portion 4100 of the guide profile 410, a distance, measured in the transverse direction Y, between the vertical longitudinal plane 450 and the curved second portion 4101 of the guide profile 410 increases from the first portion 4100 to the second edge 405 of the endpiece 4.

Advantageously, in the vicinity of the second edge 405 of the hollow body 40, a distance, measured in the transverse direction Y, between the second portion 4101 and the vertical longitudinal plane 450 is less than 5 millimeters, for example between 2.5 and 3.5 millimeters, for example around 3 millimeters.

Advantageously, a distance, measured in the longitudinal direction X, between the first edge 406 of the hollow body 40 and that part of the second portion 4101 that is furthest away from the vertical longitudinal plane 450 in the transverse direction Y is between 5 and 10 millimeters, for example between 7.5 and 8.5 millimeters, for example around 8 millimeters;

It should be noted, as shown in FIGS. 2a and 2b, that a width, measured in the transverse direction Y, of the deflecting device 41 decreases in the direction toward the second edge 405 of the endpiece 4. In other words, the deflecting device 41 becomes thinner transversely in the direction toward the second edge 405 of the endpiece 4, notably at the second portion 4101 of its guide profile 41.

Several embodiments of the endpiece 4 according to the invention will now be described.

FIG. 3a illustrates more particularly an endpiece 4 like the one shown in FIGS. 2a and 2b and according to a first embodiment. FIG. 3a illustrates the endpiece 4 in a side view, which is to say, with reference to the directions defined above, in a view in a vertical longitudinal plane. FIG. 3a shows the windshield wiper 500, its first part 1 and its air deflector 10, and also the squeegee blade 2 and the endpiece 4, its hollow body 40 and its deflecting device 41, and also the first edge 406 and the second edge 405 of the hollow body 40. More specifically, FIG. 3a shows the front lateral wall 400a of the hollow body 40, and also the deflecting device 41 and its guide profile 410. As shown in FIG. 3a, the guide profile 410 of the deflecting device 41 has the substantially rectilinear first portion 4100 and the curved second portion 4101.

In a way which is specific to the first embodiment illustrated in FIG. 3a, a height, measured in the vertical direction Z, of the deflecting device 41 between the upper wall 401 of the hollow body 40 and the second portion 4101 of the guide profile 410 decreases from the first portion 4100 in the direction toward the second edge 405, or even up to the second edge 405 of the endpiece 4. In other words, the height of the deflecting device 41 between the upper wall 401 of the hollow body 40 and an apex of the deflecting device 41 represented by its guide profile 410 decreases in the direction toward the second edge 405 of the endpiece 4 at the second portion 4101 of said guide profile 410. In this first exemplary embodiment of the invention illustrated in FIG. 3a, the guide profile 410 of the deflecting device 41 of the endpiece 4 thus has a substantially rectilinear shape over the first portion 4100, the deflecting device 41 having a constant height there over the entire first portion 4100; and the guide profile 410 of the deflecting device 41 of the endpiece 4 has a curved shape oriented in the direction toward the front lateral wall 400a on the second portion 4101, the deflecting device 41 having a decreasing height there over the entire second portion 4101.

In this first embodiment of the endpiece 4 according to the invention, the second portion 4101, or amplification portion 4101a, is curved both:
in relation to the plane 450 shown in FIG. 2a and containing the longitudinal direction X and the guide profile 410, and
in relation to a transverse longitudinal plane, not shown in FIG. 3a, which contains notably the first portion 4100 of the guide profile 410.

Advantageously, the difference between the height of the deflecting device 41, measured at the end shared by the first portion 4100 and the second portion 4101 of the guide profile 410, and the height of the deflecting device 41, measured at the second edge 405 of the endpiece 4, is around a few millimeters, preferably less than 5 millimeters, for example between 1.5 and 2.5 millimeters. According to an advantageous example, this difference in height is around 2 millimeters.

According to different variants of this first embodiment of the invention, the decrease in height of the deflecting device 41 along the second portion 4101 of the guide profile 410 and in the direction toward the second edge 405 of the endpiece 4 may be linear or non-linear. If this variation in height is linear, the height of the deflecting device 41 in the second portion 4101 decreases constantly in the direction toward the second edge 405 of the endpiece 4. In other words, in a side view, the guide profile 410 of the deflecting device 41 has, in its second portion 4101, a substantially rectilinear shape in the direction toward the second edge 405 of the endpiece 4.

According to the example illustrated more particularly in FIG. 3a, the decrease in height of the deflecting device 41 in the aforementioned curved portion 4101 is non-linear, such that, in a side view as illustrated in FIG. 3a, the guide profile 410 of the deflecting device 41 has, in its second portion 4101, a curved shape in the direction toward the second edge 405 of the endpiece 4.

FIG. 3b illustrates more particularly an endpiece 4 like the one shown in FIGS. 2a and 2b and according to a second embodiment. FIG. 3b illustrates the endpiece 4 in a side view, which is to say, with reference to the directions defined above, in a view in a vertical longitudinal plane. FIG. 3b shows the windshield wiper 500, its first part 1 and its air deflector 10, and also the squeegee blade 2 and the endpiece 4, its hollow body 40 and its deflecting device 41, and also the first edge 406 and the second edge 405 of the hollow body 40. More specifically, FIG. 3b shows the front lateral wall 400a of the hollow body 40, and also the deflecting device 41 and its guide profile 410. As shown in FIG. 3b, the guide profile 410 of the deflecting device 41 has the substantially rectilinear first portion 4100 and the curved second portion 4101.

In a way which is specific to the second embodiment illustrated in FIG. 3b, a height, measured in the vertical direction Z, of the deflecting device 41 between the upper wall 401 of the hollow body 40 and the second portion 4101 of the guide profile 410 is constant over the entire second portion 4101. In other words, the height of the deflecting device 41 between the upper wall 401 of the hollow body 40 and an apex of the deflecting device 41 represented by its guide profile 410 is identical at all points of the second portion 4101 of the guide profile 410 at the second portion 4101 of said guide profile 410. In this second exemplary embodiment of the invention illustrated in FIG. 3b, the guide profile 410 of the deflecting device 41 of the endpiece 4 thus has a substantially rectilinear shape over the first portion 4100, the deflecting device 41 having a constant height there over the entire first portion 4100; and the guide profile 410 of the deflecting device 41 of the endpiece 4 has a curved shape oriented in the direction toward the front lateral wall 400a on the second portion 4101, the deflecting device 41 having a constant height there over the entire second portion 4101.

In this second embodiment of the endpiece 4 according to the invention, the second portion 4101, or amplification portion 4101a, is curved solely in relation to the plane 450 shown in FIG. 2a and containing the longitudinal direction X and the guide profile 410.

FIG. 3c illustrates more particularly an endpiece 4 like the one shown in FIGS. 2a and 2b and according to a third embodiment. FIG. 3c illustrates the endpiece 4 in a side view, which is to say, with reference to the directions defined above, in a view in a vertical longitudinal plane. FIG. 3c shows the windshield wiper 500, its first part 1 and its air deflector 10, and also the squeegee blade 2 and the endpiece 4, its hollow body 40 and its deflecting device 41, and also the first edge 406 and the second edge 405 of the hollow body 40. More specifically, FIG. 3c shows the front lateral wall 400a of the hollow body 40, and also the deflecting device 41 and its guide profile 410. As shown in FIG. 3c, the guide profile 410 of the deflecting device 41 has the substantially rectilinear first portion 4100 and the curved second portion 4101.

In a way which is specific to the third embodiment illustrated in FIG. 3c, a height, measured in the vertical direction Z, of the deflecting device 41 between the upper wall 401 of the hollow body 40 and the second portion 4101 of the guide profile 410 increases from the first portion 4100 in the direction toward the second edge 405, or even up to the second edge 405 of the endpiece 4. In other words, the height of the deflecting device 41 between the upper wall 401 of the hollow body 40 and an apex of the deflecting device 41 represented by its guide profile 410 increases in the direction toward the second edge 405 of the endpiece 4 at the second portion 4101 of said guide profile 410. In this third exemplary embodiment of the invention illustrated in FIG. 3c, the guide profile 410 of the deflecting device 41 of the endpiece 4 thus has a substantially rectilinear shape over the first portion 4100, the deflecting device 41 having a constant height there over the entire first portion 4100; and the guide profile 410 of the deflecting device 41 of the endpiece 4 has a curved shape oriented in the direction toward the front lateral wall 400a on the second portion 4101, the deflecting device 41 having an increasing height there over the entire second portion 4101.

In this third embodiment of the endpiece 4 according to the invention, the second portion 4101, or amplification portion 4101a, is curved both:
in relation to the plane 450 shown in FIG. 2a and containing the longitudinal direction X and the guide profile 410, and
in relation to a transverse longitudinal plane, not shown in FIG. 3c, which contains notably the first portion 4100 of the guide profile 410.

Advantageously, the difference between the height of the deflecting device 41, measured at the end shared by the first portion 4100 and the second portion 4101 of the guide profile 410, and the height of the deflecting device 41, measured at the second edge 405 of the endpiece 4, is around a few millimeters, preferably less than 5 millimeters, for example between 1.5 and 2.5 millimeters. According to an advantageous example, this difference in height is around 2 millimeters.

According to different variants of this third embodiment of the invention, the increase in height of the deflecting device 41 along the second portion 4101 of the guide profile 410 and in the direction toward the second edge 405 of the endpiece 4 may be linear or non-linear. If this variation in height is linear, the height of the deflecting device 41 in the second portion 4101 increases constantly in the direction toward the second edge 405 of the endpiece 4. In other words, in a side view, the guide profile 410 of the deflecting device 41 has, in its second portion 4101, a substantially rectilinear shape in the direction toward the second edge 405 of the endpiece 4.

According to the example illustrated more particularly in FIG. 3c, the increase in height of the deflecting device 41 in the aforementioned curved portion 4101 is non-linear, such that, in a side view as illustrated in FIG. 3c, the guide profile 410 of the deflecting device 41 has, in its second portion 4101, a curved shape in the direction toward the second edge 405 of the endpiece 4.

In summary, the invention proposes an endpiece 4 for a windshield wiper 500 of a motor vehicle, the shape and dimensions of which make it possible to ensure an effective downforce to the end of the endpiece 4, thus ensuring that the squeegee blade 2 of the windshield wiper 500 is effectively and successfully pressed against a glazed surface to be wiped/cleaned of the motor vehicle. This effective downforce is notably obtained by virtue of a curved shape of the guide profile 410 along which the deflecting device located above the hollow body 40 extends, the curved shape of said guide profile 410 being oriented toward a front lateral wall 400a of the endpiece 4 according to the invention.

Of course, the invention is not limited to the examples that have just been described and numerous modifications can be made to these examples without departing from the scope of the invention. In particular, the various features and embodiment variants of the invention can be combined with one another in various ways, provided that they are not mutually exclusive or incompatible. In particular, all of the variants and embodiments described above can be combined with one another.

What is claimed is:

1. An endpiece of a windshield wiper for a motor vehicle, comprising:
a hollow body extending, in a longitudinal direction, between a first edge configured to be in engagement with a windshield wiper end and a second, free, edge configured to be remote from the windshield wiper end;
an airstream deflecting device projecting from the hollow body along a guide profile defined by the set of apexes of the deflecting device relative to the hollow body, the deflecting device extending between the first edge and the second edge of the hollow body;
wherein the guide profile of the deflecting device has an amplification portion curved in a plane parallel to the longitudinal direction and including the guide profile.

2. The endpiece as claimed in claim 1, wherein the guide profile of the deflecting device has:
a first portion along which the deflecting device has a constant shape; and
a second portion forming the amplification portion, the second portion being located in the continuation of the first portion.

3. The endpiece as claimed in claim 1, wherein the amplification portion has a curved shape, the curvature of which is directed toward a front lateral wall of the hollow body.

4. The endpiece as claimed in claim 1, wherein a height of the deflecting device varies in increasing fashion along the amplification portion and in the direction toward the second edge of the hollow body.

5. The endpiece as claimed in claim 1, wherein a height of the deflecting device varies in decreasing fashion along the amplification portion and in the direction toward the second edge of the hollow body.

6. The endpiece as claimed in claim 1, wherein a height of the deflecting device is constant along the amplification portion.

7. The endpiece as claimed in claim 1, wherein, at a part of the amplification portion which is proximal to the second end of the hollow body, a width of the deflecting device is less than the width of the deflecting device at the first edge of the hollow body.

8. A windshield wiper comprising a squeegee blade and a support element, and wherein the squeegee blade is secured to the support element by an endpiece, with the endpiece including a hollow body extending, in a longitudinal direction, between a first edge configured to be in engagement with a windshield wiper end and a second, free, edge configured to be remote from the windshield wiper end, an airstream deflecting device projecting from the hollow body along a guide profile defined by the set of apexes of the deflecting device relative to the hollow body, the deflecting device extending between the first edge and the second edge of the hollow body, and wherein the guide profile of the deflecting device has an amplification portion curved in a plane parallel to the longitudinal direction and including the guide profile.

9. A wiper system for a glazed surface of a motor vehicle, comprising:
a windshield wiper including a squeegee blade and a support element, and wherein the squeegee blade is secured to the support element by an endpiece, with the endpiece including a hollow body extending, in a longitudinal direction, between a first edge configured to be in engagement with a windshield wiper end and a second, free, edge configured to be remote from the windshield wiper end, an airstream deflecting device projecting from the hollow body along a guide profile defined by the set of apexes of the deflecting device relative to the hollow body, the deflecting device extending between the first edge and the second edge of the hollow body, and wherein the guide profile of the deflecting device has an amplification portion curved in a plane parallel to the longitudinal direction and including the guide profile, the windshield wiper being intended to be brought into contact with the glazed surface,
a wiper arm configured to drive the windshield wiper in rotation,
a connection device configured to securely fix the windshield wiper to the wiper arm.
